(19) United States
(12) Patent Application Publication
(10) Pub. No.: US 2003/0222215 A1
(43) Pub. Date: Dec. 4, 2003

(54) Method for objective and accurate thickness measurement of thin films on a microscopic scale

(76) Inventors: Quentin de Robillard, Dresden (DE); Holger Saage, Dresden (DE); Heiko Stegmann, Dresden (DE); Hans-Jurgen Engelmann, Dresden (DE)

Correspondence Address: J. Mike Amerson, Williams, Morgan & Amerson, P.C., Suite 250, 7676 Hillmont, Houston, TX, 77040, US

(21) Appl. No.: 10/285,044

(22) Filed: Oct. 31, 2002

(30) Foreign Application Priority Data
May 31, 2002 (DE) 102 24 195.3

(51) Int. Cl. G01N 23/06

(52) U.S. Cl. 250/311; 250/307

(57) ABSTRACT

In a method and an apparatus for determining the thickness of a thin layer coated on a surface, a section is prepared and a digital image of the section is obtained. An intensity profile in the thickness direction of the layer is extracted from the digital image and is analyzed on the basis of predefined characteristics of the intensity profile to precisely determine the layer thickness. This technique is particularly advantageous in determining the layer thickness when said layer is formed on a curved surface.

### BACKGROUND OF THE INVENTION

1. Field of the Invention

The present invention relates to measurement techniques in which the thickness of thin films, in the range of nanometers down to atomic dimensions, have to be determined. In particular, the present invention relates to measurement techniques requiring the preparation of thin samples to obtain measurement data by radiation of small wavelengths, such as electrons, passing through the sample.

2. Description of the Related Art

The deposition of thin films on any type of substrate has become one of the most important technologies of surface modification. The development and the production of a huge number of products requires the deposition of various coating materials and functional coatings, such as tribological, hard, high-temperature, conductive and dielectric, optical, biotechnological and decorative coatings, with a precisely adjusted thickness on various surface topologies. Since the final performance of a product may significantly be determined by the quality of the deposited thin film, precise control during manufacturing of the products is essential.

Furthermore, modem deposition techniques require great efforts in terms of energy and equipment so that any failure in producing a thin film of the required quality remarkably contributes to the overall cost of the product. An illustrative example in this respect is the fabrication of modem integrated circuits, wherein at various manufacturing stages, material layers have to be deposited with different composition and layer thickness on differently patterned structures. Incorrectly depositing a material layer on a 200 mm diameter wafer—a commonly used substrate size in manufacturing sophisticated integrated circuits—at a final stage of the manufacturing process may thus lead to the loss of several tens of thousands of dollars.

Consequently, a plurality of measurement methods have been developed for high precision measurement of thin films. Most of these methods, however, are concerned with measurements of the thickness, even down to a few atomic layers, wherein the thin film is coated on a substantially planar surface. These well-established methods are not very effective when the film whose thickness is to be measured is provided on non-planar surfaces exhibiting a curvature on the sub-millimeter scale. Moreover, the problem often arises that one or more layers have to be examined, which are enclosed by other material layers that do not allow direct inspection of the layer of interest. In particular, when the layer of interest is provided with a thickness in the nanometer range on a structure including elements in the order of some hundreds of nanometers to a few micrometers, as for example in micro-electronics or micro-mechanics, the method of choice for determining is electron-microscopy. One method, preferentially used for structures in the nanometer range down to atomic dimensions, is transmission electron microscopy (TEM) that allows resolving the structures of interest with sufficient resolution to precisely determine a layer thickness of a thin film.

When recording a TEM image for the purpose of measuring a layer thickness, electron-optical conditions are chosen that allow one to treat the image as a very good approximation of a two-dimensional, parallel projection of the sample volume under consideration. One major issue in determining a layer thickness from such a TEM image is the loss of the three-dimensional information when generating this two-dimensional projection. This issue is even exacerbated when the thin film is provided on non-planar structures.

With reference to FIGS. 1a-1d and 2a-2d, the problems involved in determining a layer thickness by means of TEM will be described in more detail. In FIG. 1a, a schematic perspective view of a portion 100 of a structure (not shown) is depicted. It should be noted that the portion 100 may be enclosed by further materials that are not shown in FIG. 1a, so that the portion 100 may only form a small part of the total structure. The portion 100 comprises a thin film 101 having a thickness 102 that is to be determined by the TEM measurement. The thin film 101 may be enclosed by a first material 103 and a second material 104 that, at least in some properties, differ from the material comprising the thin film 101. In TEM measurements, a section has to be prepared, the thickness of which is sufficiently small to allow the charged particles passing therethrough. In order to accurately determine the layer thickness 102, the section with a thickness of a few hundred nanometers or less is prepared substantially perpendicularly to a longitudinal direction, indicated as 105. The section to be made, indicated by reference 106, is shown in dashed lines.

FIG. 1b shows a schematic perspective view of the section 106 of FIG. 1a and of a corresponding TEM image 110 obtained by exposing the section 106 to an electron beam 107 that substantially perpendicularly impinges on the section 106. Due to the different properties of the materials 103, 104 and the thin film 101, the amount of electrons scattered by the various materials is different and a corresponding two-dimensional projection 108 of the section 106 is obtained on the image 110. Thus, for an idealized thin film 101 having sharp boundaries to the neighboring materials 103 and 104, the projection 108 of the thin film 101 will also exhibit sharp boundaries to the adjacent image portions, wherein a thickness 109 of the protection 108 precisely corresponds to the thickness 102 of the thin film 101. Of course, any magnification caused by the electron lenses for generating the final image 110, has to be taken into consideration when estimating the thickness 102 by means of the thickness 109 of the projection 108. For the sake of simplicity, any magnification effects in FIG. 1b are not depicted.

According to the process illustrated in FIGS. 1a and 1b, the thickness 102 of the thin film 101 may be precisely determined under the assumption that the section 106 may be prepared in an ideal manner as shown in FIGS. 1a and 1b. In reality, however, preparing an appropriate section for TEM analysis requires a great deal of skill and experience of an operator, since generally a large sample, such as a semiconductor substrate, has to be cut precisely at the location where the structure to be measured is expected to be located and the cut substrate has to be thinned to the appropriate thickness in the hundred nanometer range and beyond so as to avoid undue scattering of electrons. Cutting slices of samples may be accomplished by mechanical milling and thinning the samples may be obtained by advanced ion beam milling and polishing methods. In any case, preparing the section 106 is quite complex and often produces a non-ideal section as will be explained with reference to Figures 1c and 1d.

In FIG. 1c, the section 106 that is to be prepared from the portion 100 is, owing to any inaccuracies during orienting the portion 100 in cutting and thinning, tilted with respect to a direction orthogonal to the longitudinal direction 105, as indicated by an angle α.

FIG. 1d shows the section 106 with its surface oriented to the electron beam 107 in the same manner as depicted in FIG. 1b. Consequently, the thickness of the thin film 101 appears to be larger, determined by the tilt angle α, and is now indicated as 102′. The electrons passing through the section 106 will encounter a varying degree of scattering along the thickness direction and will produce the projection 108 with a correspondingly enlarged thickness 109′. Accordingly, an operator inspecting the TEM image 110 will most likely predict a thickness for the thin film 101 that is inaccurate and thus strongly depends on the operator's skill and experience. Hence, determining a layer thickness of a thin film is extremely sensitive to variations in preparing the section and also significantly depends on the operator's skill of interpreting the TEM image.

This situation becomes even more exacerbated, when a thin film is coated on a structure including a curvature when the order of magnitude of the curvature is comparable to a thickness of the section. In order to more clearly demonstrate the problems with thin films provided on a curved structure, reference will now be made to FIGS. 2a-2d.

In FIG. 2a, a schematic cross-sectional view of a semiconductor structure 200 is shown. The structure 200 may comprise a substrate 220, such as a silicon substrate, which may comprise one or more circuit elements (not shown) that in combination form an integrated circuit. A dielectric layer 221 is formed on the substrate 220 and may comprise, for example, silicon dioxide as is often used as an interlayer dielectric in integrated circuits. In the dielectric layer 221, a via 222 is formed having dimensions in accordance with design requirements. For example, the via 222 may provide contact to any underlying circuit feature and may have a diameter of approximately 0.2 μm or even less, when sophisticated integrated circuits are considered. For the sake of convenience, a single contact region 223 is deposited and is meant to represent a contact portion of an underlying circuit feature. On the inner surfaces of the via 222, a thin film 201 is formed having a thickness 202. For example, the thin film 201 may represent a barrier diffusion layer comprised of, for example tantalum, titanium, titanium nitride, tantalum nitride, and the like, as is typically used in the fabrication of integrated circuits. Moreover, the via 222 is to be filled with an appropriate contact metal such as tungsten, aluminum, copper and the like. Depending on the type of integrated circuit, the via 222 may have an aspect ratio of 10 to 1 and, thus, deposition of the thin film 201 involves highly sophisticated deposition methods, wherein it is extremely important to provide the thickness profile of the thin film 201 with high precision according to design requirements. Usually, it is desired to provide the thin film 201 with a specific thickness, which may vary at the various locations in the via 222, such as at the top region 225 and the bottom region 224. In sophisticated integrated circuits with copper lines, the thin film layer 201 may prevent copper from diffusing into the neighboring materials, while at the same time the thin film 201 has to provide a sufficient conductivity to the underlying contact region 223 so as not to unduly degrade the performance of the complete copper plug. Thus, deposition of the thin film 201 has to be carried out within very tightly set limits. Therefore, a very accurate determination of the thickness 202 at the various locations of the via 222 is essential for appropriately adjusting deposition parameters. For the TEM analysis of the thin film 201, a section 206 has to be prepared that includes the via 222.

FIG. 2b shows a top view of the structure 200 as shown in FIG. 2a. As is evident from FIG. 2b, even if advanced sample preparation techniques are employed, a thickness 224 of the section 206 will contain a portion 225 of the thin film 201 having a curvature defining curved edge portions 226.

FIG. 2c shows a schematic perspective view of the section 206, wherein the curved edges 226 of the thin film 201 are visible. It should be noted, that the bottom portion 224 of the via 222 is formed on the substantially planar contact region 223 so that the bottom of the via 222 does not substantially comprise curved edges such as the edges 226 provided on the sidewalls of the via 222.

FIG. 2d schematically shows, in an over-simplified manner, the arrangement used to obtain a TEM image of the thin film 201. An electron source 230, configured to provide an electron beam 207 with required characteristics to provide a TEM image 210, is positioned to emit the electrons 207 onto the section 206. As is evident from FIG. 2d, although the thin film 201 has the thickness 202, this thickness 202 does not translate into a thickness 209 of a two-dimensional projection 208 of the thin film 201. Rather, the thickness 209 of the projection 208 represents the projection including the curvature of the thin film 201 and thus does not allow the precise determination of the actual thickness 202 on the basis of the TEM image 210. Similar to the situation as described with reference to FIGS. 1a-1d, the determination of the thickness 202 is strongly affected by the skills and experience of the corresponding operator. Moreover, the situation becomes even worse when the section 206 may not be prepared as an extremely thin sample, since then the contribution of the curvature to the entire thickness 209 of the projection 208 is increased. In particular, determining the thickness 202 at the sidewall compared to the thickness 202 at the bottom of the via 222 without a curved edge may thus yield quite different results, thereby erroneously indicating a significant non-uniformity obtained during the deposition process.

In view of the above-mentioned problems, it would be highly desirable to eliminate or at least reduce the influence of the quality of the section and an operator's skill and experience on the result of the TEM measurements.

### SUMMARY OF THE INVENTION

Generally, the present invention is directed to a method and an apparatus in which loss of the three-dimensional information is, at least partially, compensated for by obtaining an intensity profile of a two-dimensional projection in an image generated by short wave length radiation, such as an electron beam, wherein structural characteristics, such as curved edges of thin film and/or a tilt angle in preparing the section, including the thin film of interest, are taken into account by analyzing the intensity profile on the basis of properties that are substantially independent from structural characteristics and tilt angles.

According to one illustrative embodiment of the present invention, a method of determining the thickness of a thin film comprises preparing a cross-sectional specimen of the film and irradiating the film with a radiation beam substantially perpendicularly to a thickness direction of the film so as to provide a digital image of the specimen. The method further includes extracting an intensity profile from the digital image, substantially parallel to the thickness direction, and analyzing the intensity profile of the digital image to determine the thickness of the film. In a further embodiment, the thin film is a curved thin film.

In a further illustrative embodiment of the present invention, a method of determining the thickness of a material layer formed in a substrate comprises preparing a section of the substrate, exposing a layer indicative of a layer thickness and obtaining a digital image of at least a portion of the section from radiation passing through the section. The method further includes extracting an intensity profile from the image substantially perpendicular to a thickness direction of the layer, and estimating the layer thickness on the basis of at least one predefined characteristic of the intensity profile.

Pursuant to a further illustrative embodiment of the present invention, an apparatus for determining the thickness of a curved thin film comprises a radiation source configured to irradiate a specimen of the curved film and a particle detector configured to detect radiation passing through the specimen to provide a digital image of the specimen. The apparatus further comprises an extraction unit configured to extract an intensity profile from the digital image and an analyzer for analyzing the intensity profile of the digital image.

According to still another illustrative embodiment of the present invention, an apparatus for determining the thickness of a material area formed in a substrate comprises a radiation source configured to emit a, beam of radiation of predefined characteristics and a detector configured and arranged to detect radiation passed through a section placed between the radiation source and the detector. Moreover, an extraction unit is provided that is configured to extract an intensity profile from a digital image along a predefined direction in the digital image. Additionally, a calculation unit is configured to determine a layer thickness of the material layer on the basis of at least one predefined characteristic of the intensity profile.

### BRIEF DESCRIPTION OF THE DRAWINGS

The invention may be understood by reference to. the following description taken in conjunction with the accompanying drawings, in which like reference numerals identify like elements, and in which:

FIGS. 1a-1d show schematic perspective views of a structure including a thin film for which a TEM image is to be gathered;

FIGS. 2a-2d schematically show cross-sectional views and perspective views of a typical application in determining the thickness of a thin film, wherein the thin film is coated on a structured surface;

FIG. 3a schematically depicts an apparatus for determining a layer thickness according to one illustrative embodiment of the present invention;

FIG. 3b schematically shows a further embodiment of an apparatus that allows precise measurements of thin films;

FIG. 4a schematically depicts a perspective view of a curved film and the projection thereof;

FIG. 4b shows the structure of FIG. 4a with an area for extracting an intensity profile; and

FIG. 4c depicts an intensity profile obtained from the structure depicted in FIGS. 4a and 4b in accordance with one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

As previously noted, the present invention is based on the inventors' finding that the loss of the third dimension in producing a transmission image of a thin sample including a thin film, the thickness of which has to be determined, may be compensated for by extracting an intensity profile of the projected image of the thin film and analyzing the intensity profile. The analysis may be based upon typical characteristics of the intensity profile that are substantially independent from properties of the sample, such as sample thickness, radius of curvature of the thin film in a thickness direction of the thin film, and a tilt angle introduced during the preparation of the sample. Such sample-independent characteristics and criteria may be, for example, any extrema of the profile curve, appropriately set threshold values in predefined regions of the profile curve, and the like. The interaction of moderate energy radiation and charged particles with matter is well-understood and therefore suitable criteria for estimating profile curves may be obtained by carrying out simulation calculations regarding the sample to be measured. Moreover, the results of the simulations may be used to establish reference data or sets of reference data in which variations of parameters, such as sample thickness and/or layer thickness of a thin film to be measured, and the like, are taken account of, so that the reference data may be compared to the measurement data to determine the layer thickness. Hence, since such characteristics and/or criteria and/or reference data may be determined in an objective manner, influences of the sample preparation methods used and an operator's influence on estimating a transmission image may be substantially reduced or eliminated.

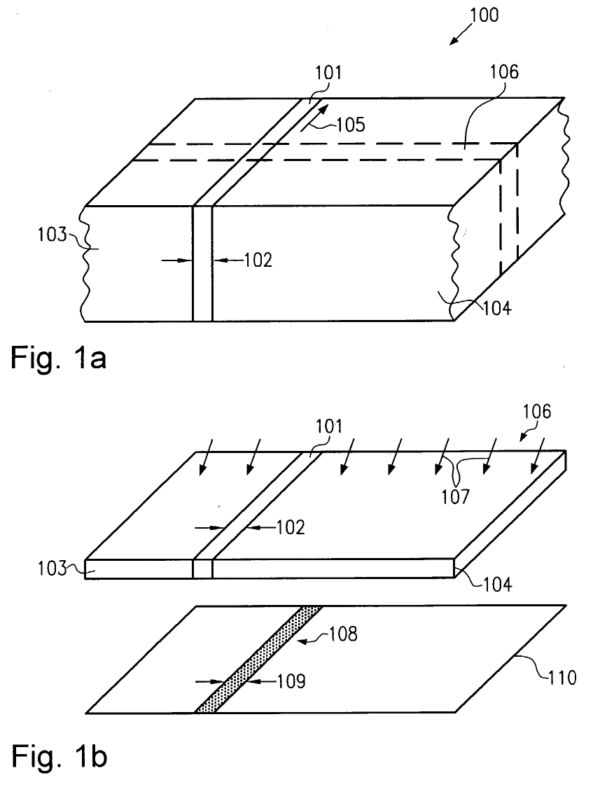

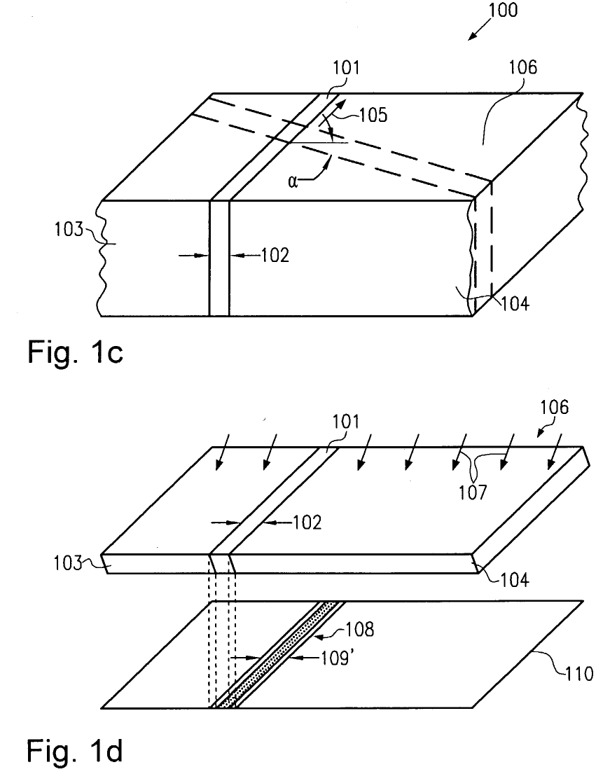

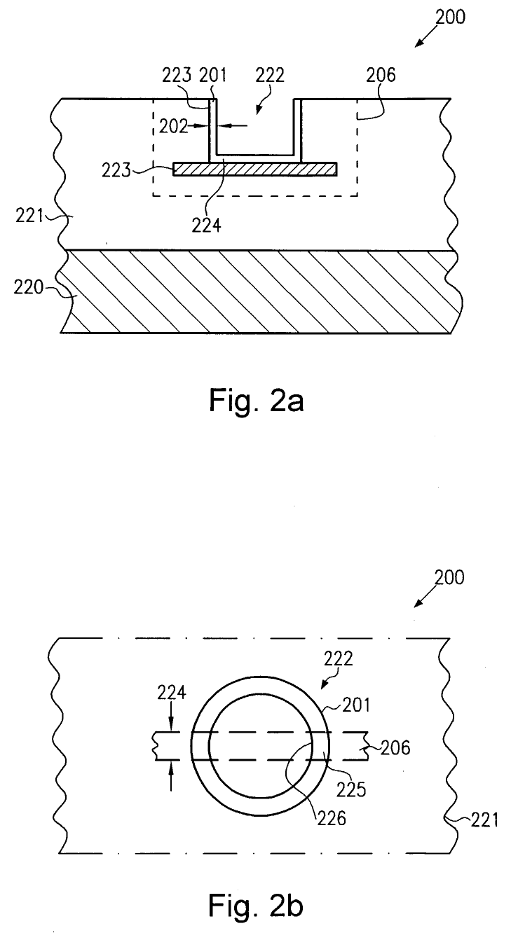

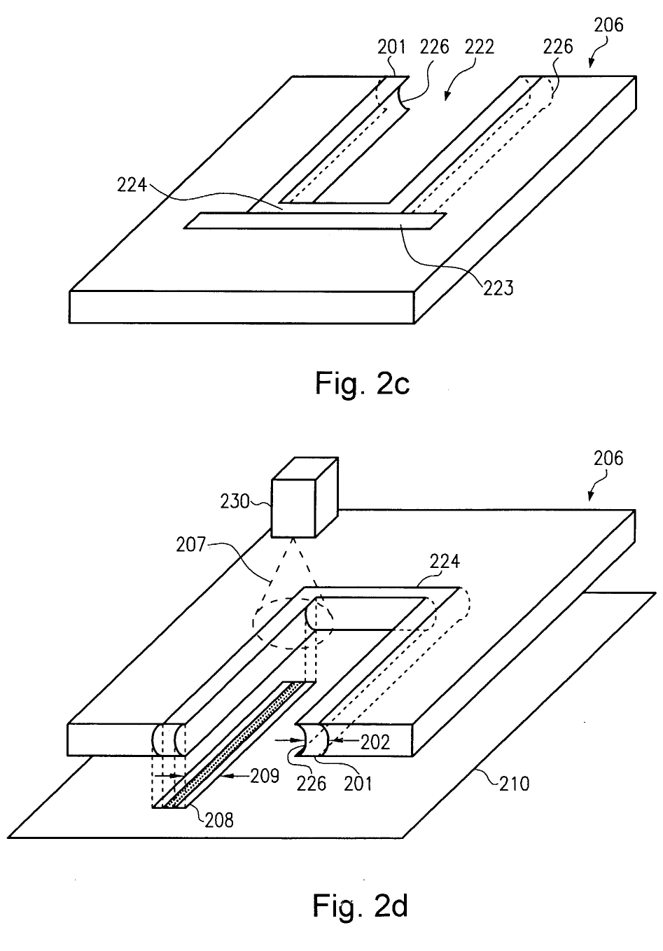

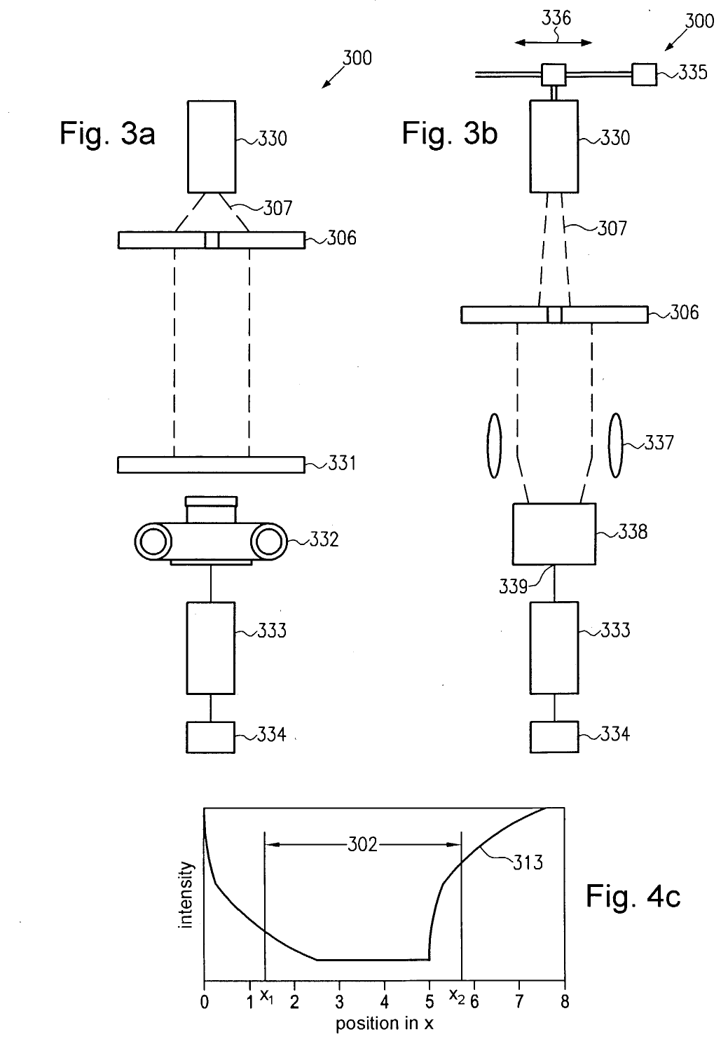

With reference to FIGS. 3a and 3b, illustrative embodiments of apparatus allowing objective and precise thickness measurements will now be described. In FIG. 3a, an apparatus 300 comprises a radiation source 330 that is configured to emit a beam of radiation 307 of required characteristics. For instance, the radiation source 330 may be an electron source as used in a standard transmission electron microscope. It should be noted, however, that the principles of the present invention may be readily applied to any radiation source emitting a radiation with a wavelength that is sufficient to precisely resolve the structures to be investigated. Thus, the radiation source 330 may represent an x-ray source, an ion beam source and the like. The apparatus 300 further comprises any of a variety of known means for receiving, positioning and holding in place a sample, such as the section already described with reference to FIGS. 1 and 2. So as to not obscure the present invention, such means are not expressly shown in the attached drawings. For the sake of simplicity, this means, as well as the sample, will be commonly indicated by reference number 306. In one embodiment, a standard TEM apparatus may be used as the radiation source 330 and the means 306.

The apparatus 300 further comprises a screen 331 configured and arranged to receive any radiation that has passed the sample 306. For instance, the screen 331 may be adapted to produce light of appropriate wavelength upon incidence of a portion of the radiation 307. Moreover, an image generating means 332 is provided and arranged so as to receive the light generated by the screen 331 and to generate an image corresponding to the radiation incident on and converted by the screen 331. For example, the image generating means 332 may be a digital camera that produces an image, which may readily be stored and subjected to further electronic processing. In other embodiments, the image generating means 332 may be a standard analog device coupled to a scanner device that allows digitizing an analog image obtained from the image generating means 332. An extraction unit 333 is configured to receive an image from the image generating means 332 or any other appropriate device that allows the generation of a digital image representing the distribution of radiation that has arrived on the screen 331. The extraction unit may be directly coupled to the image generating means 332 or may be a stand-alone device. The extraction unit 333 is configured to obtain one or more intensity profiles of a predefined portion of the digital image supplied to the extraction unit 333. In one embodiment, the extraction unit 333 may have implemented an image processing unit that allows analysis of the information contained in the digital image on a pixel basis. Thus, the extraction unit 333 may be adapted to select a certain region of interest of the digital image and to provide the contents representing the selected region to a calculation unit 334 that is adapted to perform any required manipulation on the pixel content supplied by the extraction unit 333. The extraction unit 333 and the calculation unit 334 may be implemented in a common control unit, such as a computer device, wherein the computer may communicate with the image generating means 332, or the computer may receive image data by an operator, and the like. For example, the calculation unit 334 may be adapted to determine gray scales on a pixel basis and compare the gray scales to predefined reference values so as to extract information regarding the intensity distribution in the region of interest, i.e., of one or more intensity profiles provided by the extraction unit 333. Such information may include extrema of the intensity profile, any plateaus in the intensity profile and the like.

In another embodiment, the calculation unit 334 may have a required computational power and resources including an appropriate instruction set to provide for an advanced image processing of the digital image.

FIG. 3b schematically shows a variation of the apparatus of FIG. 3a according to a further illustrative embodiment of the present invention. In FIG. 3b, parts that are identical to those described in FIG. 3a are denoted by the same reference numerals and a corresponding description of these parts is omitted. In FIG. 3b, the apparatus 300 comprises the radiation source 330 adapted to emit the beam of radiation 307 with the required characteristics. Other than in the embodiment shown in FIG. 3a, a positioning system 335 is provided and is mechanically coupled to the radiation source 330. The positioning system 335 is configured to move the radiation source 330 in at least one direction, as indicated by arrow 336, by correspondingly moving the radiation source 330 to thereby enable the beam 307, exhibiting a relatively small radiation spot at the location of the sample 306, to be scanned over the sample 306. In other embodiments, additionally or alternatively, the sample 306 may be supported by a corresponding sample positioning system (not shown) that allows moving the sample 306 relative to the radiation source 330. The apparatus 300 further comprises a beam optical system 337 that is configured to direct the radiation 307 emitted by the radiation source 330 and passed through the sample 306 onto a detector 338 that has a sufficient spatial resolution for the measurements to be performed. An output 339 of the detector 338 may be configured to supply digital information to the extraction unit 333.

Thus, the embodiments of FIG. 3a differ from the embodiments of FIG. 3b in that the radiation transmitted through the sample 306 may directly be converted into a digital image without requiring the screen 331 as shown in FIG. 3a. Moreover, the apparatus 300 of FIG. 3b may be operated in a scan mode so that the apparatus of FIG. 3b allows one to select a region of interest by correspondingly positioning the radiation source 330 and/or the sample 306.

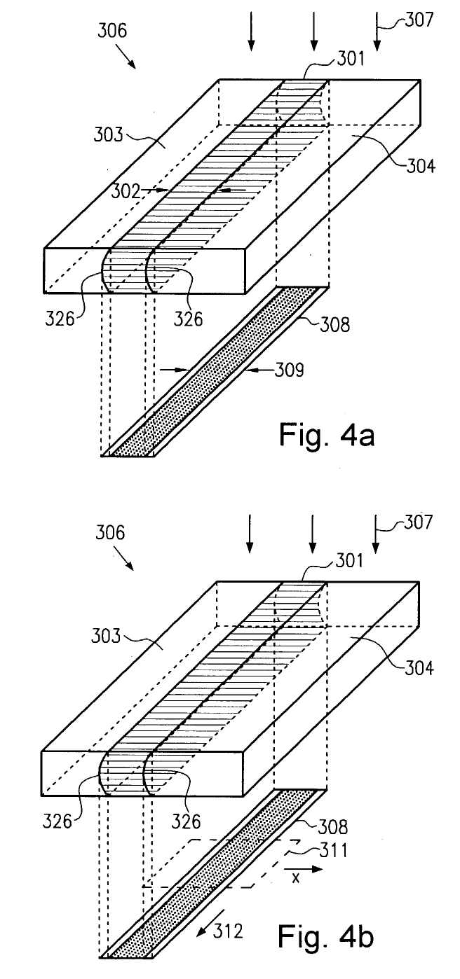

The operation of the apparatus 300 shown in FIGS. 3a and 3b will now be described with reference to FIGS. 4a-4c irrespective of the mode of irradiating the sample 306. In FIG. 4a, a schematic perspective view of a portion of the sample 306 is shown. The sample may include a via, such as the via 222, as shown in FIGS. 2a-2d. Thus, the sample 306 comprises a thin film 301 having curved edges 326, wherein a thickness of the thin film resting on a curved surface is to be determined. Regarding the preparation of the sample 306, the same criteria apply as already explained with reference to FIGS. 1 and 2. Upon illumination with the beam 307, for example comprised of electrons, a portion of the radiation is absorbed in accordance with the properties of the material forming the thin film 301. Since a neighboring material 303 or 304 differs in at least one property from the material of the thin film 301, a two-dimensional projection 308 is obtained, the thickness 309 of which is, however, affected by the magnitude of the curvature of the curved edges 326 as is previously explained with reference to FIGS. 2a-2d. Thus, the digital image 310 including the projection 308 and generated by the screen 331 in combination with the image generating means 332, when the apparatus 300 of FIG. 3a is considered, or that is directly generated by the detector 338, when the apparatus 300 of FIG. 3b is considered, does not allow a precise determination of an actual thickness 302 of the thin film 301 for the same reasons as already pointed out earlier.

In FIG. 4b, by means of the extraction unit 333 a region of interest 311 of the digital image 310 is selected that includes partially the projection 308. The region of interest 311 may be selected according to requirements, such as desired position, characteristics of the thin film 301, contrast of the projection 308 and the like. The region of interest 311 is selected to at least include a transition to the neighboring regions 303 and 304. In one embodiment, the region of interest 311 may represent a single pixel line of the digital image 310, taken along a direction that is substantially perpendicular to a length direction 312 defined by the thin film 301. In another embodiment, as shown in FIG. 4b, the region of interest 311 extends along the direction 312 and thus may include a plurality of sections of the projection 308. The corresponding plurality of sections, each representing a single intensity profile, may then be summed and weighted to establish an averaged intensity profile of the region of interest 311. In this way, any fluctuations between individual pixel lines representing a section of the projection 308 may be smoothed. In one embodiment, averaging a plurality of intensity profiles may automatically be performed once the region of interest 311 is selected by an operator.

FIG. 4c shows a diagram depicting a typical intensity profile 313 taken along a direction substantially perpendicular to the longitudinal direction 312, which will also be referred to as x direction. In FIG. 4c, the intensity, i.e., the gray scale of the pixels, is depicted on the vertical axis whereas the position in x is depicted in the horizontal direction. The intensity profile 313 extracted by the extraction unit 333 may then be subjected to further analysis by calculation unit 334, since the shape of the intensity profile 313 is strongly affected by the characteristics of the sample 306, such as the thickness thereof, the characteristics of the materials comprising the regions 303, 304 and the thin film 301. For example, if the electron scattering capability of the regions 303 and 304 is quite similar to that of the thin film 301, a minimum as depicted in FIG. 4c will be significantly less accentuated and, thus, estimation of the thickness 301 requires further analysis. To this end, the interaction of the beam 307, for example comprised of electrons, with the materials included in the sample 306 may be calculated by means of well-established routines that exactly describe the interaction of matter with electromagnetic radiation and charged particles. In these calculations, the thickness of the sample 306 may be varied to take account of any impreciseness in preparing the sample 306. For example, a plurality of thicknesses of the sample may be assumed and the corresponding “responses,” for instance in the form of contrast differences between the regions 303, 304 and 301, of the (simulated) sample 306 may be calculated. The results of the simulation may then be used to establish a corresponding set of reference data that may be compared to actual measurement data, or, in other embodiments, the results may be used to determine criteria as to how to determine the precise location of a transition between two adjacent regions in the sample 306. For instance, threshold values ×1 and ×2 may be determined in the transition regions of adjacent materials, that is, in the falling edge and the rising edge of the intensity profile 313, which specify the actual thickness 302.

Alternatively or additionally, the magnitude of the curvature of the curved edges 326 and/or the thickness of the (simulated) thin film 306 may be varied to establish a set of possible “responses” of the thin film 301 to the incident beam 307. The corresponding set of reference data may then be compared to the actual measurement results so as to determine the actual thickness 301 on the basis of the result of the comparison.

In one embodiment, the direction of the simulated incident beam 307 is varied for a plurality of different thicknesses 302 of the thin film 301 and a plurality of different thicknesses of the sample 306. Thus, corresponding reference intensity profiles may be obtained, in which a tilt angle possibly introduced during the preparation of the (actual) sample 306 is compensated for by varying the (simulated) angle of incidence of the beam 307. The reference data may then be compared to the measurement data to extract the thickness 302. These reference data may be obtained at any appropriate time and may be stored in a library to be available for subsequent measurements.

It is to be noted that extracting an intensity profile from a digital image of a sample is also advantageous in precisely determining the layer thickness of a thin film coated on a substantially planar surface, as is shown FIGS. 1a-1d, or the bottom region 224 of the via 222, as shown in FIGS. 2a-2d. Thus, any imperfections in preparing a sample including these “planar” features, i.e., introducing a tilt angle in cutting the sample, that may conventionally result in an inaccurate determination of the thickness may effectively be compensated by obtaining an intensity profile and analyzing the intensity profile in the above explained manner. For example, by precisely obtaining the actual thickness, such as the thickness 102 of the thin film 101 in FIGS. 1a-1d, from the thickness 109′ (FIG. 1d), the tilt angle α (FIG. 1c) may be determined. The knowledge regarding the tilt angle α may be advantageous in further analyzing the sample of interest or in estimating the quality of the sample preparation technique.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of determining the thickness of a film, the method comprising:
preparing a cross-sectional specimen of the film;
irradiating the film with a radiation beam substantially perpendicularly to a thickness direction of the film so as to provide a digital image of the specimen;
extracting an intensity profile from said digital image, substantially parallel to said thickness direction; and
analyzing the intensity profile of the digital image to determine the thickness of the film.

2. The method of claim 1, wherein preparing said specimen comprises sectioning a sample substantially perpendicularly to said thickness direction.

3. The method of claim 1, wherein analyzing the intensity profile of the digital image comprises detecting extrema of said intensity profile.

4. The method of claim 1, further comprising obtaining reference data of said intensity profile by performing simulation calculations.

5. The method of claim 1, further comprising executing simulation calculations of intensity profiles of said specimen to deduce well-defined criteria to determine the thickness in said intensity profile.

6. The method of claim 1, further comprising selecting a region of interest in said digital image, said region of interest including a projection of the thickness of the film, determining one or more intensity profiles in said selected region of interest, and obtaining an averaged intensity profile.

7. The method of claim 1, wherein analyzing the intensity profile of the digital image comprises selecting predefined portions of the intensity profile and determining an averaged intensity in each of the predefined portions.

8. The method of claim 7, wherein said predefined portions of the intensity profile include a falling edge and a rising edge of said intensity profile.

9. The method of claim 4, wherein performing simulation calculations includes varying a thickness of said specimen so as to obtain a set of reference data for a plurality of different specimen thicknesses.

10. The method of claim 4, wherein said thin film is a curved thin film and wherein performing said simulation calculations includes varying at least one of a radius of curvature of said curved film and a thickness of the thin film to establish a set of reference data.

11. The method of claim 4, wherein performing said simulation calculations includes varying an angle of incidence of said radiation beam.

12. The method of claim 1, wherein said radiation beam is an electron beam.

13. A method of determining the thickness of a material layer formed in a substrate, the method comprising:
preparing a section of the substrate, exposing a layer indicative of a layer thickness;
obtaining a digital image of at least a portion of said section from radiation passing through said section;
extracting an intensity profile from said image substantially perpendicular to a thickness direction of said layer; and
estimating said layer thickness on the basis of at least one predefined characteristic of said intensity profile.

14. The method of claim 13, wherein said at least one predefined characteristic is determined by means of simulation calculations describing the interaction of said radiation with material contained in said section.

15. The method of claim 13, wherein said at least one predefined characteristic includes one or more extrema of a function representing said intensity profile.

16. The method of claim 13, wherein said material layer is formed on a substantially planar substrate and wherein the method further comprises determining a tilt angle of the section with respect to the thickness direction of the layer on the basis of said intensity profile.

17. The method of claim 13, further comprising obtaining reference data of said intensity profile by performing simulation calculations.

18. The method of claim 13, further comprising
selecting a region of interest in said digital image, said region of interest including a projection of the thickness of the layer;
determining one or more intensity profiles in said selected region of interest, and obtaining an averaged intensity profile.

19. The method of claim 13, wherein estimating said layer thickness comprises selecting predefined portions of the intensity profile and determining an averaged intensity in each of the predefined portions.

20. The method of claim 19, wherein said different portions of the intensity profile include a falling edge and a rising edge of said intensity profile.

21. The method of claim 14, wherein performing simulation calculations includes varying a thickness of said section so as to obtain a set of reference data for a plurality of different section thicknesses.

22. The method of claim 14, wherein performing said simulation calculations includes varying a thickness of the layer to establish a set of reference data.

23. The method of claim 14, wherein performing said simulation calculations includes varying an angle of incidence of said radiation.

24. The method of claim 13, wherein said radiation is an electron beam.

25. An apparatus for determining the thickness of a film, the apparatus comprising:
a radiation source configured to irradiate a specimen of the film;
a particle detector configured to detect radiation passing through the specimen to provide a digital image of the specimen;
an extraction unit configured to extract an intensity profile from said digital image; and
an analyzer for analyzing the intensity profile of the digital image.

26. The apparatus of claim 25, wherein the extraction unit is further configured to allow the selection of a region of interest in said digital image.

27. The apparatus of claim 26, wherein the extraction unit is further configured to automatically calculate an average intensity profile of said region of interest.

28. The apparatus of claim 25, wherein said radiation source is an electron source.

29. The apparatus of claim 25, wherein said analyzer is further adapted to perform simulation calculations.

30. The apparatus of claim 29, wherein said analyzer is further adapted to store results of said simulation calculations as reference data.

31. An apparatus for determining the thickness of a material layer formed in a substrate, the apparatus comprising:
a radiation source configured to emit a beam of radiation of predefined characteristics;
a detector configured and arranged to detect radiation passed through a section placed between the radiation source and the detector;
an extraction unit configured to extract an intensity profile from a digital image along a predefined direction in said digital image; and
a calculation unit configured to determine a layer thickness of said material layer on the basis of at least one predefined characteristic of said intensity profile.
